(19) United States
(12) Patent Application Publication
(10) Pub. No.: US 2010/0053815 A1
(43) Pub. Date: Mar. 4, 2010

(54) GLIDE HEAD AND MAGNETIC STORAGE DEVICE

(75) Inventor: Hitoshi Komoriya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/490,890

(22) Filed: Jun. 24, 2009

(30) Foreign Application Priority Data
Aug. 29, 2008 (JP) 2008-222474

(51) Int. Cl. G11B 5/60

(52) U.S. Cl. 360/234.3; G9B/5.229

(57) ABSTRACT

A glide head includes a slider configured to float by airflow generated by rotation of a recording medium and detects a contact between the recording medium and the slider. The slider includes a floating rail. The floating rail includes a surface facing the recording medium and including an obtuse-angled corner. The floating rail is configured such that a rear end thereof is formed into a wedge shape and a thickness thereof is maximized at the obtuse-angled corner.

### CROSS-REFERENCE TO RELATED APPLICATION(S)

This application is based upon and claims the benefit of priority of the prior Japanese Patent Application No. 2008-222474, filed on Aug. 29, 2008, the entire contents of which are incorporated herein by reference.

### FIELD

The embodiments discussed herein are directed to a glide head that includes a slider configured to float by airflow generated by rotation of a recording medium and detects a contact between the recording medium and the slider, and a magnetic storage device provided with the glide head.

### BACKGROUND

Conventionally, a manufacturing process of a magnetic disk medium includes a detection step of detecting a protrusion on the medium by using a component called “glide head” provided with piezoelectric element. In the detection step, the medium is rotated to cause a slider mounted with the glide head to float by airflow generated above the medium, and, if the slider comes into contact with the protrusion on the medium, the piezoelectric element generates a voltage to thereby detect the protrusion based on a detection of the voltage (see, Japanese Laid-open Patent Publication No. 2002-190109).

Meanwhile, a magnetic disk medium called “patterned media” is being developed. The patterned media has a different structure than the conventional magnetic disk medium formed of magnetic particles deposited on a glass substrate or a metallic substrate, in that the patterned media is formed of an array of magnetic particles as magnetic dots independent of each other. A manufacturing process of such patterned media also includes a detection step of detecting a protrusion on the medium by using the glide head.

However, in the conventional technology described above, there is a problem that a protrusion on a medium as a part of the patterned media is erroneously detected. This is because it is difficult to produce a flat surface of the patterned media in view of manufacturing costs and the like, so that a difference in level between the magnetic dots and the rest of the surface of the patterned media remains. When the slider of the glide head moves towards such a difference, the slider may vibrate and thus may come into contact with the medium, resulting in causing the piezoelectric element to generate a voltage. However, in the conventional technology, no measure is provided to distinguish a voltage generated as a result of a contact between the slider and a protrusion as an obstacle from a voltage generated as a result of a contact between the slider and the medium due to the vibration. Thus, there is a demand for accurately detecting a protrusion as an obstacle on a medium even if the medium to be examined is the patterned media.

### SUMMARY

According to an aspect of the invention, a glide head includes a slider configured to float by airflow generated by rotation of a recording medium and detects a contact between the recording medium and the slider. The slider includes a floating rail. The floating rail includes a surface facing the recording medium and including an obtuse-angled corner. The floating rail is configured such that a rear end thereof is formed into a wedge shape and a thickness thereof is maximized at the obtuse-angled corner.

According to an another aspect of the invention, a glide head includes a slider configured to float by airflow generated by rotation of a recording medium and detects a contact between the recording medium and the slider. The slider includes a first floating rail and a second floating rail symmetrically arranged with respect to a center of the slider in such a manner that a distance between front ends of the first and second floating rails is set different from a distance between rear ends of the first and second floating rails. Each of the first and second floating rails includes a surface facing the recording medium and including a most rear end corner and a rear end corner next to the most rear end corner. Each of the first and second floating rail is configured such that a thickness thereof is maximized at the rear end corner next to the most rear end corner.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIGS. 1A to 1C illustrate standard magnetic patterns of patterned media;

FIGS. 2A to 2C are schematic diagrams of a slider of a glide head according to a first embodiment of the present invention, viewed from three different sides;

FIG. 3 is a schematic diagram for explaining a portion at an airflow outlet end of a slider and at which the slider comes closer to a medium;

FIGS. 4A to 4C are schematic diagrams of a modified example of the slider of the glide head according to the first embodiment, viewed from three different sides;

FIGS. 5A to 5C are schematic diagrams of a slider of a glide head according to a second embodiment of the present invention, viewed from three different sides; and

FIG. 6 is a schematic diagram of a magnetic storage device provided with the glide head according to the first and the second embodiments.

### DESCRIPTION OF EMBODIMENT(S)

Preferred embodiments of the present invention will be explained with reference to the accompanying drawings.

### [a] First Embodiment

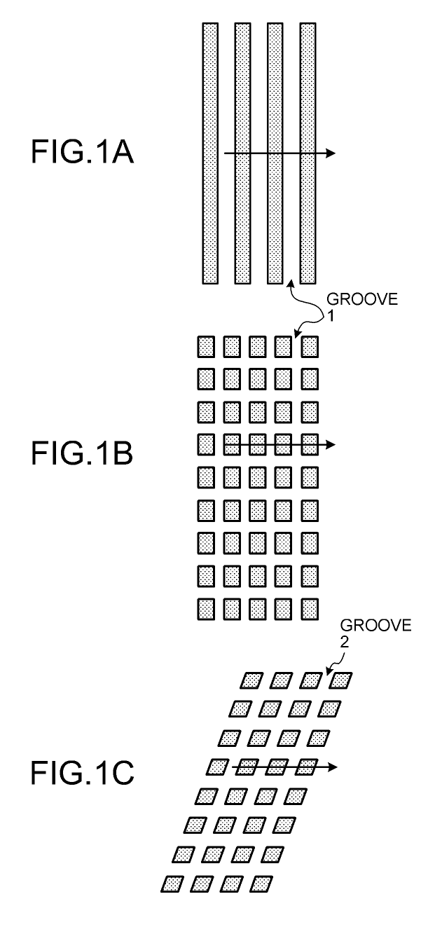

Standard magnetic patterns of patterned media are described below. FIGS. 1A to 1C illustrate standard magnetic patterns of patterned media. More particularly, FIG. 1A illustrates a preamble pattern, FIG. 1B illustrates a data pattern, and FIG. 1C illustrates a servo pattern. In the preamble pattern, information, such as read-write timing and information for adjusting frequencies, necessary for reading and writing information from and in the data pattern and the servo pattern are recorded. In the data pattern, arbitrary user data is recorded. In the servo pattern, information for positioning a magnetic head is recorded.

When a medium having one of the magnetic patterns illustrated in FIGS. 1A to 1C rotates, a slider of a glide head is caused to float by buoyant airflow generated above the medium. When floating, the slider moves in directions indicated by arrows illustrated in FIGS. 1A to 1C above the preamble pattern, the data pattern, and the servo pattern, respectively. The preamble pattern and the data pattern have grooves 1 perpendicular to a moving direction of the slider. The servo pattern has grooves 2 making an angle of 30 degrees or smaller with respect to the moving direction of the slider. The depth of each of the grooves 1 and the grooves 2 is set to 1 nanometer or deeper. In the currently-known technology, it is difficult to completely remove these grooves to produce a flat medium surface in view of manufacturing costs.

In the conventional technology, a slider of a glide head is configured such that a portion at an airflow outlet end of the slider and at which the slider comes close to a medium is set to parallel or substantially parallel to the grooves 1 and the grooves 2. With this configuration, the slider is caused to float by buoyancy above the patterns and fall due to immediate decrease in the buoyancy above the grooves in a repetitive manner. That is, a floating force of the slider fluctuates. As a result, the slider may vibrate and thus may come into contact with the medium.

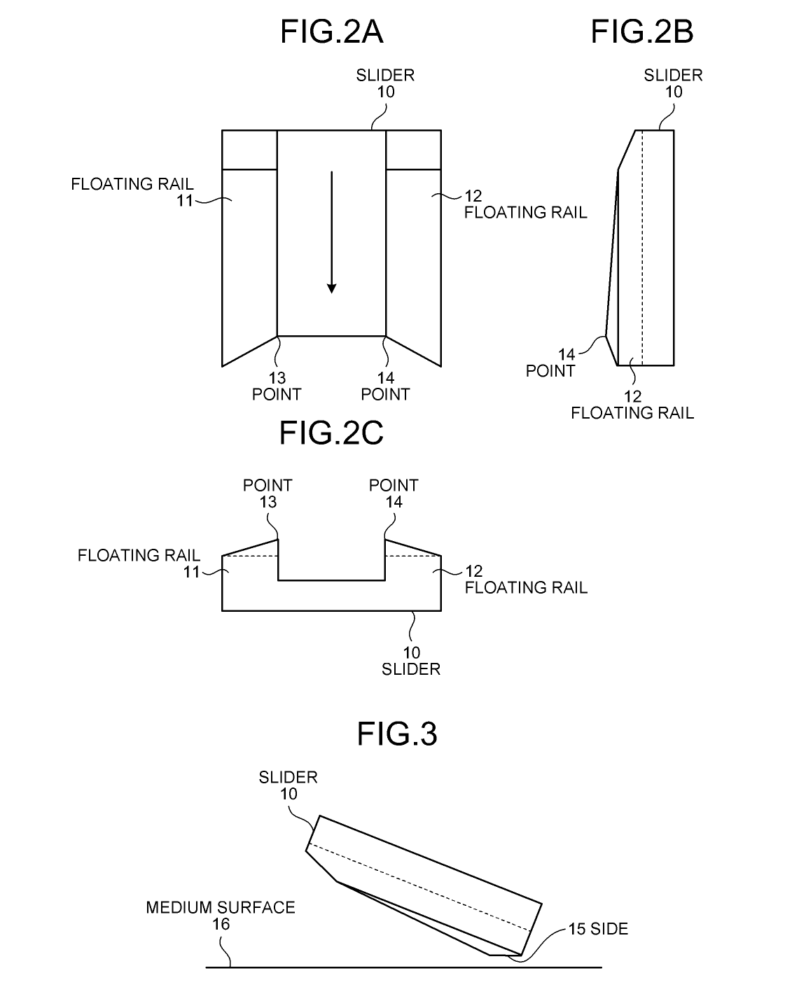

A glide head according to a first embodiment of the present invention includes a slider as illustrated in FIGS. 2A to 2C. FIGS. 2A to 2C are schematic diagrams of the slider of the glide head according to the first embodiment, viewed from three different sides. More particularly, FIG. 2A is a plan view of the slider viewed from a side facing a medium, FIG. 2B is a side view of the slider, and FIG. 2C is an elevational view of the slider. As illustrated in FIG. 2A, a slider 10 includes a floating rail 11 and a floating rail 12. The slider 10 receives, while floating, airflow in a direction indicated by an arrow illustrated in FIG. 2A. Airflow outlet ends of the floating rails 11 and 12 are inclined with respect to the direction of the airflow. The inclination angle is preferably set in a range from 30 degrees to 60 degrees. Besides, as illustrated in FIGS. 2B and 2C, the floating rails 11 and 12 are structured such that inner sides thereof are protruded so that thicknesses thereof are maximized at points 13 and 14, respectively. More particularly, as illustrated in FIG. 3, the level of protrusion is preferably set so that a side 15 may be set to substantially parallel to a medium surface 16 when the slider 10 is caused to float by airflow above the medium. The side 15 is a line connecting the point 14 and a rear end of the floating rail 12 as illustrated in FIG. 2B.

Because of this structure, the airflow outlet ends of the floating rails 11 and 12 are inclined with respect to the grooves 1 and 2 illustrated in FIGS. 1A to 1C when the slider 10 moves over the medium, so that buoyancy of the slider 10 does not immediately decrease. In other words, influences due to the grooves can be averaged, so that the floating force of the slider 10 can be stabilized, resulting in preventing the slider 10 from vibrating. Accordingly, piezoelectric element can hardly generate a voltage because of vibration and a resultant contact of the slider 10 with a medium. Thus, a voltage is generated only when the slider 10 comes into contact with a protrusion as an obstacle. As a result, the glide head having the slider 10 can detect the projection as an obstacle on the patterned media.

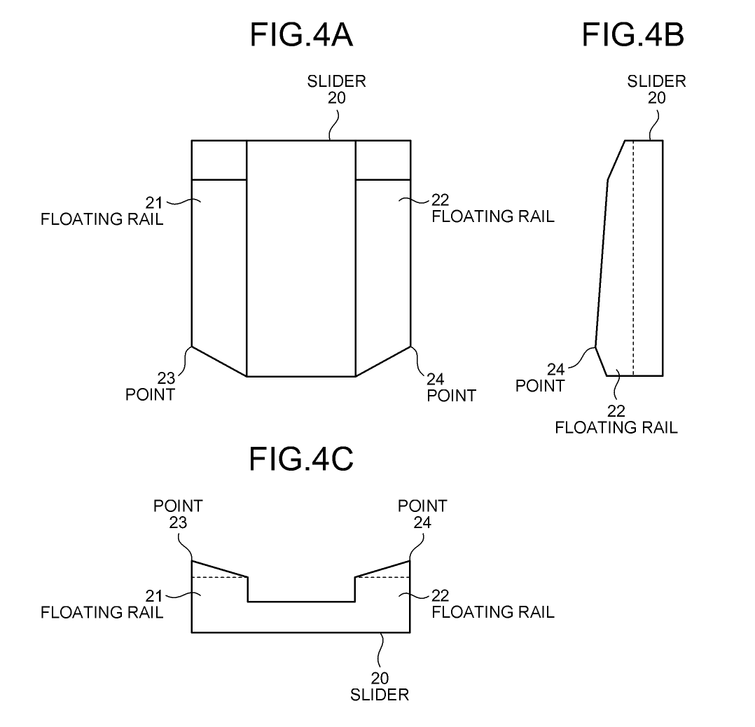

The rear ends of the floating rails of the slider can be formed into any wedge shapes. For example, the slider can be shaped as illustrated in FIGS. 4A to 4C. FIGS. 4A to 4C are schematic diagrams of a modified example of the slider of the glide head according to the first embodiment, viewed from three different sides. More particularly, FIG. 4A is a plan view of the slider viewed from a side facing a medium, FIG. 4B is a side view of the slider, and FIG. 4C is an elevational view of the slider. As illustrated in FIG. 4A, airflow outlet ends of a floating rail 21 and a floating rail 22 of a slider 20 are reversely inclined compared to the floating rails 11 and 12 of the slider 10 illustrated in FIGS. 2A to 2C, with respect to the moving direction of the airflow. In this case, as illustrated in FIGS. 4B and 4C, the floating rails 21 and 22 are structured such that outer sides thereof are protruded so that thicknesses thereof are maximized at points 23 and 24, respectively.

### [b] Second Embodiment

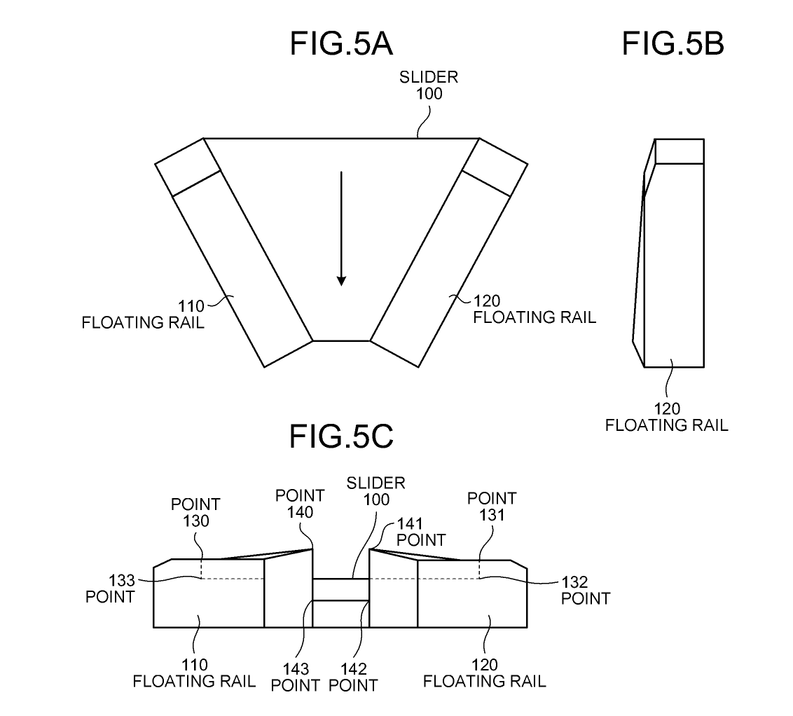

A structure of a slider of a glide head according to a second embodiment of the present invention is illustrated in FIGS. 5A to 5C. FIGS. 5A to 5C are schematic diagrams of the slider of the glide head according to the second embodiment, viewed from three different sides. More particularly, FIG. 5A is a plan view of the slider viewed from a side facing a medium, FIG. 5B is a side view of the slider, and FIG. 5C is an elevational view of the slider. As illustrated in FIG. 5A, a slider 100 includes a floating rail 110 and a floating rail 120. The slider 100 receives, while floating, airflow in a direction indicated by an arrow illustrated in FIG. 5A. The floating rails 110 and 120 are configured such that a distance between the floating rails 110 and 120 is gradually shortened from airflow inlet ends thereof to airflow outlet ends thereof without being arranged in parallel to each other. Besides, an inter-rail cross-sectional area obtained by multiplication of a depth of a groove between the rails and a width of the groove between the rails is maintained constant from the airflow inlet ends to the airflow outlet ends. For example, in the example illustrated in FIG. 5C, an area of a quadrangle with vertices 130, 131, 132, and 133 at around an airflow inlet end of the groove is set to be equal to an area of a quadrangle with vertices 140, 141, 142, and 143 at around an airflow outlet end of the groove.

With this structure, similar to the first embodiment, the airflow outlet ends of the floating rails 110 and 120 are inclined with respect to the grooves 1 and 2 illustrated in FIGS. 1A to 1C when the slider 100 moves over the medium, so that buoyancy of the slider 100 does not immediately decrease. In other words, influences due to the grooves can be averaged, so that the floating force of the slider 100 can be stabilized, resulting in preventing the slider 100 from vibrating. Accordingly, piezoelectric element can hardly generate a voltage because of vibration and a resultant contact of the slider 100 with a medium. Thus, a voltage is generated only when the slider 100 comes into contact with a protrusion as an obstacle. As a result, the glide head having the slider 100 can assuredly detect the projection as an obstacle on the patterned media.

Furthermore, the inter-rail cross-sectional area is maintained constant from the airflow inlet ends to the airflow outlet ends, so that air can flow stably through the groove between the rails. Accordingly, compared to a slider structured such that the depth of the groove between the rails is set constant, vibration of the slider can be more effectively prevented.

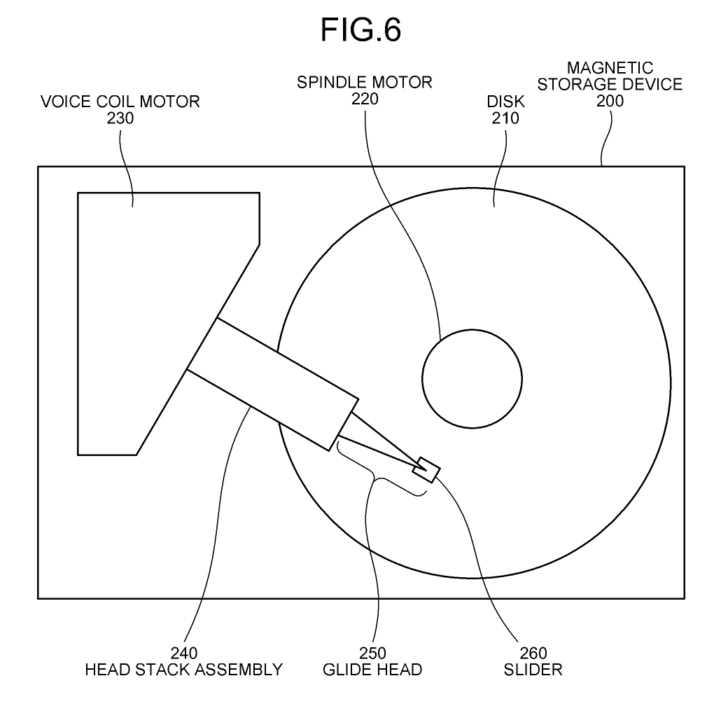

Each of the glide heads described in the first and the second embodiments is mounted on a magnetic storage device. FIG. 6 is a schematic diagram of a magnetic storage device mounted with the glide head according to the first and the second embodiments. As illustrated in FIG. 6, a magnetic storage device 200 includes a disk 210, a spindle motor 220, a voice coil motor 230, a head stack assembly 240, a glide head 250, and a slider 260. The slider 260 corresponds to the slider 10 and the slider 100 described in the first and the second embodiments.

The disk 210 is a storage medium in which information is recorded. The disk 210 is driven to rotate by the spindle motor 220. The head stack assembly 240 is driven in such a manner that an end thereof moves in an arc by the voice coil motor 230. The glide head 250 having the slider 260 is placed on the end of the head stack assembly 240.

According to an embodiment of the present invention, a protrusion as an obstacle on patterned media can be detected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A glide head that comprises a slider configured to float by airflow generated by rotation of a recording medium and detects a contact between the recording medium and the slider, wherein
the slider comprises a floating rail, and
the floating rail comprises a surface facing the recording medium and including an obtuse-angled corner, and is configured such that a rear end thereof is formed into a wedge shape and a thickness thereof is maximized at the obtuse-angled corner.

2. A glide head that comprises a slider configured to float by airflow generated by rotation of a recording medium and detects a contact between the recording medium and the slider, wherein
the slider comprises a first floating rail and a second floating rail symmetrically arranged with respect to a center of the slider in such a manner that a distance between front ends of the first and second floating rails is set different from a distance between rear ends of the first and second floating rails, and
each of the first and second floating rails comprises a surface facing the recording medium and including a most rear end corner and a rear end corner next to the most rear end corner, and is configured such that a thickness thereof is maximized at the rear end corner next to the most rear end corner.

3. The glide head according to claim 2, wherein
a depth of a groove between the first and second floating rails increases from an airflow inlet end of the groove to an airflow outlet end of the groove, and an area of a cross section of the groove normal to a moving direction of the slider is maintained constant from the airflow inlet end to the airflow outlet end.

4. A magnetic storage device including a glide head that comprises a slider configured to float by airflow generated by rotation of a recording medium and detects a contact between the recording medium and the slider, wherein
the slider comprises a floating rail, and
the floating rail comprises a surface facing the recording medium and including an obtuse-angled corner, and is configured such that a rear end thereof is formed into a wedge shape and a thickness thereof is maximized at the obtuse-angled corner.

5. A magnetic storage device including a glide head that comprises a slider configured to float by airflow generated by rotation of a recording medium and detects a contact between the recording medium and the slider, wherein
the slider comprises a first floating rail and a second floating rail symmetrically arranged with respect to a center of the slider in such a manner that a distance between front ends of the first and second floating rails is set different from a distance between rear ends of the first and second floating rails, and
each of the first and second floating rails comprises a surface facing the recording medium and including a most rear end corner and a rear end corner next to the most rear end corner, and is configured such that a thickness thereof is maximized at the rear end corner next to the most rear end corner.
